(19) United States
(12) Patent Application Publication
(10) Pub. No.: US 2021/0387368 A1
(43) Pub. Date: Dec. 16, 2021

(54) PERFORATION DEVICE FOR A DOCUMENT PROCESSING MACHINE

(71) Applicant: Plockmatic International AB, Hägersten (SE)

(72) Inventors: Tord Karlsson, Huddinge (SE); Trevor Lye, Upper Cambourne (GB); Perry Waring, Wellingborough (GB)

(21) Appl. No.: 17/304,212

(22) Filed: Jun. 16, 2021

(30) Foreign Application Priority Data
Jun. 16, 2020 (SE) 2050721-6

(51) Int. Cl. B26D 1/40; B26D 5/16

(52) U.S. Cl. CPC B26D 1/405; B26D 5/16

(57) ABSTRACT

A perforation device for a document processing machine comprising a frame, a support member and a blade member attached to the frame. The support member and the blade member are movable relative to each other. The support member is curved and the perforation device comprises a drive assembly configured to move the blade member and/or the support member in a rocking motion such that only a portion of the blade perforates the sheet wherein the portion of the blade member perforating the sheet moves along the length of the blade member as the rocking motion progresses.

### CROSS REFERENCE TO RELATED APPLICATION

This application claims priority to SE Application No. 2050721-6, filed on Jun. 16, 2020, entitled “A perforation device for a document processing machine,” the disclosure of which is incorporated by reference herein in its entirety.

### TECHNICAL FIELD

The present disclosure relates to machines for processing of documents comprising one or more sheets. Specifically, the present disclosure relates to a press assembly for pressing a blade against a sheet to thereby cause perforation of the sheet.

### BACKGROUND

Document processing machines are widely used for post-processing of printed documents comprising one or more sheets or paper or plastic. It is sometimes desirable to produce a linear perforation across a sheet but it has turned out that it is not trivial to produce a compact, yet robust, assembly for linear perforation of the sheet.

U.S. Pat. No. 2,169,799A relates to perforating machines used for effecting simultaneous perforation of a plurality of sheets of paper. The device is large and heavy and thus difficult to fit into a modern post-processing line after a printer.

GB551569A relates to a machine for perforating paper or cardboard. The machine comprises a mechanism which simultaneously presses together a blade and a support to cause perforation of the paper or cardboard. The mechanism comprises left and right levers coupled via rods and a pivot mechanism to a stepped drive wheel which moves the mechanism in response to rotation of the stepped drive wheel. The machine is large, heavy and complex and thus difficult to fit into a modern post-processing line after a printer.

U.S. Pat. No. 4,444,080A relates to a machine for perforating a web pulled between two rollers, one of which is equipped with a serrated/toothed blade extending along the length of the roller to which it is attached. The device is not suitable for perforating individual sheets, at least since it is difficult to control the position of the perforation on the sheet.

Accordingly, a first object of the invention is to provide an improved creasing device which has a small foot print whilst being robust enough to handle also sheets of dense quality and sheets other than paper or cardboard, such as plastic sheets.

### SUMMARY

According to a first aspect of the invention, the first object and other objects is achieved by a perforation device as defined in claim 1 with specific alternative embodiments defined in the dependent claims. The perforation device is for a document processing machine and comprises a frame, a support member and a blade member attached to the frame. The support member and the blade member are movable relative to each other and configured to cooperate by movement between an open position in which a gap for insertion of a sheet is present between the support member and the blade member, and a perforating position in which the gap is at least partially closed such that at least a portion of the sheet is pressed between the support member and the blade member such that the sheet is perforated. The support member is curved and the perforation device comprises a drive assembly configured to move the blade member and/or the support member in a rocking motion such that only a portion of the blade perforates the sheet wherein the portion of the blade member perforating the sheet moves along the length of the blade member as the rocking motion progresses.

The combination of a curved support member or blade and a rocking motion moving them relative to each other enables the perforation line to be achieved progressively throughout the rocking motion with only a smaller portion of the blade member active at a time. This greatly reduces the force needed to force the blade into the sheet to perforate it and thus enables an overall leaner design of the perforation device whilst still being robust enough for the task at hand.

The drive assembly may comprise a rotatable shaft, wherein a left cam member is attached to the shaft at a left portion of the shaft, and wherein a right cam member is attached to the shaft at a right portion of the shaft. The blade member may be provided with a left cam follower configured to cooperate with the left cam member to control the movement of the left portion of the blade member in response to rotation of the shaft. Also, the blade member may be provided with a right cam follower configured to cooperate with the right cam member to control the movement of the right portion of the blade member in response to rotation of the shaft.

Each one of the left cam member and the right cam member may comprise a respective rotary bearing defining a respective cylindrical cam surface. The rotary bearing is attached off-center with respect to the central axis of the shaft.

The use of a rotary bearing for the cam surface reduces wear of the cam follower since the cam surface merely rolls on the cam follower rather than slide past the cam follower. This increases life time of the cams and the cam follower and reduces the need of service of the perforation device. The left cam member may be attached to the shaft with an angular offset to the right cam member with respect to said central axis.

The relative angular offset of the cam members provides for the rocking motion whilst using identical cam members and thus enables a smooth and symmetric rocking motion.

The perforation device may further comprise biasing means configured to force apart the blade member and the support member.

The biasing means force the blade against the cam members such that the blade always follows the cam members without relying on gravity. Hence, the machine is able to work in all orientations.

According to a second aspect, a document processing device comprising an integrated perforation device as described above may be provided.

### BRIEF DESCRIPTION OF DRAWINGS

FIGS. 1-4 show a perforation device according to a first embodiment of the invention in different positions.

FIG. 1 shows the perforation device in an open position for receiving a sheet to be perforated.

FIGS. 2-4 show the rocking motion in a sequence from side to side, starting with perforation at the right side in FIG. 2, gradually moving on to perforating the central portion in FIG. 3 and finally perforating the left portion in FIG. 4.

FIG. 5 shows a schematic side view of the shaft provided with the left cam member and the right cam member. As shown, the left and right cam members are angularly offset with respect to the rotational axis of the shaft in order to jointly control the movement of the support member upon rotation of the shaft through said rocking motion and further to the open position.

```
  1 perforation device
  2 frame
  3 support member
  4 blade member
  5 gap
  6 rotatable shaft
  7 left cam member
  8 right cam member
  9 left cam follower
10 right cam follower
11 rotary bearings
12 central axis
13 angular offset
14 drive belt
```

### DETAILED DESCRIPTION

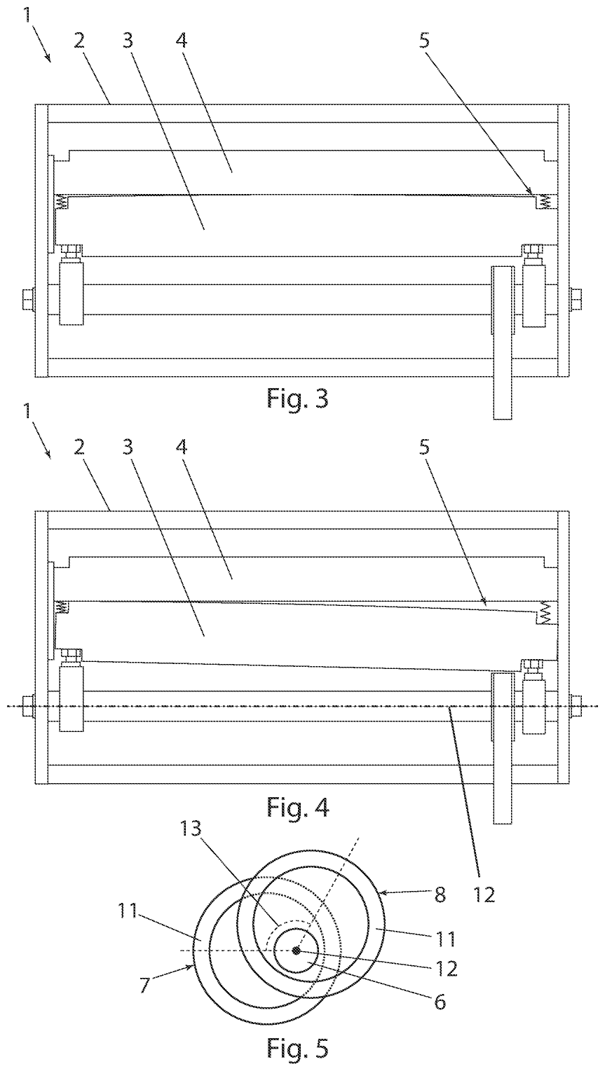

A first embodiment of the perforation device will hereinafter be described with reference to the appended drawings. The perforation device 1 is for a document processing machine such as a printer or copier. The perforation device 1 is used to perforate sheets of paper, plastic or similar materials normally used for printed information, flyers, booklets, etc. The perforation device 1 comprises a frame 2, a support member 3 and a blade member 4 attached to the frame 2, wherein the support member 3 and the blade member 4 are movable relative to each other and configured to cooperate by movement between an open position in which a gap 5 for insertion of a sheet is present between the support member 3 and the blade member 4, and a perforating position in which the gap is at least partially closed such that at least a portion of the sheet is pressed between the support member 3 and the blade member 4 such that the sheet is perforated. In order to achieve the perforation at only a portion of the length of the perforation to be made, the support member 3 is curved and moved such that the portion of the curve being closest to the blade member 4 varies from left to right and vice versa, as shown in FIGS. 2-4. The smaller contact length/area currently active for perforating the sheet, needs less pressure than what would have been required if the whole perforation length would be active at the same time. In order to effect the relative movement between blade member 4 and support member 3, the perforation device 1 comprises a drive assembly configured to move the blade member 4 and/or the support member 3 in a rocking motion such that only a portion of the blade member 4 perforates the sheet. The portion of the blade member 4 perforating the sheet moves along the length of the blade member 4 as the rocking motion progresses.

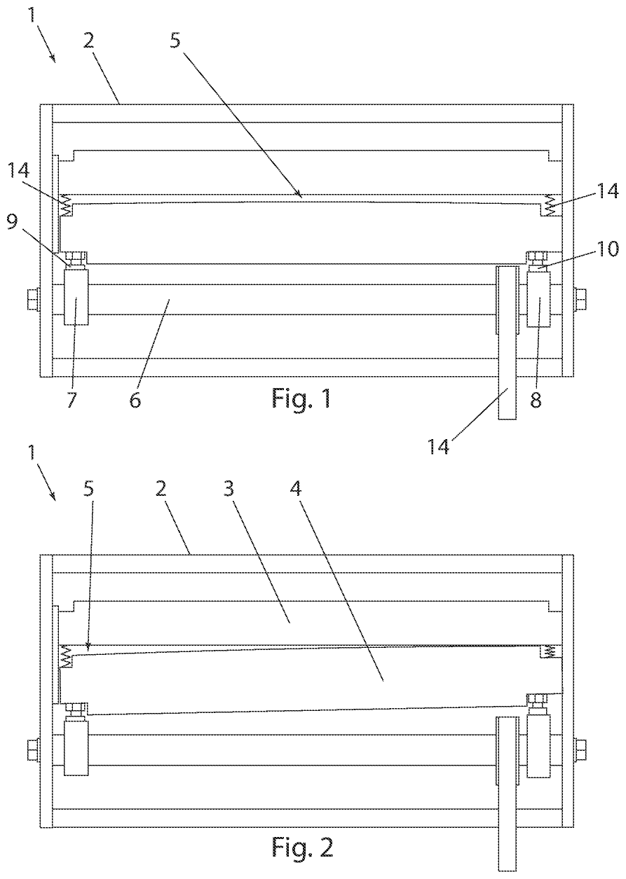

The drive assembly comprises a rotatable shaft 6, wherein a left cam member 7 is attached to the shaft 6 at a left portion of the shaft 6, wherein a right cam member 8 is attached to the shaft 6 at a right portion of the shaft 6. The blade member 4 is provided with a left cam follower 9 configured to cooperate with the left cam member 7 to control the movement of the left portion of the blade member 4 in response to rotation of the shaft 6. Also, the blade member 4 is provided with a right cam follower 10 configured to cooperate with the right cam member 8 to control the movement of the right portion of the blade member 4 in response to rotation of the shaft 6. A drive motor (not shown) drives a belt 14 (see FIG. 1) which drives the shaft 6. In other embodiments, any other suitable drive means could be used to rotate the shaft 6.

Each one of the left cam member 7 and the right cam member 8 comprises a respective rotary bearing 11 defining a respective cylindrical cam surface, where the rotary bearing 11 is attached off-center with respect to the central axis 12 of the shaft 6. In other embodiments, a fixed profile defining the guide surface of the cam could alternatively be attached to the shaft 6 instead of the rotary bearings 11 but that would increase friction and wear of the cam follower as compared to the easily rotatable rotary bearing 11.

As shown in FIG. 5, the left cam member 7 is attached to the shaft 6 with an angular offset 13 to the right cam member with respect to said central axis 12. The angular offset enables the left and right portions of the support to be differently offset from the blade at any given rotational position of the shaft 6, thereby providing the rocking motion upon rotation of the shaft 6.

Also, the perforation device 1 comprises a biasing means 14 configured to force apart the blade member 4 and the support member 3. In this embodiment, one coil spring is provided for forcing apart the left portions of the support member 3 and the blade, and another coil spring is provided for forcing apart the right portions of the support member 3 and the blade member 4.

The perforation device 1 is typically mounted in a document processing device such as a printer and may be manufactured and sold as an integrated system.

1. A perforation device (1) for a document processing machine, wherein the perforation device (1) comprises a frame (2), a support member (3) and a blade member (4) attached to the frame (2), wherein the support member (3) and the blade member (4) are movable relative to each other and configured to cooperate by movement between an open position in which a gap (5) for insertion of a sheet is present between the support member (3) and the blade member (4), and a perforating position in which the gap is at least partially closed such that at least a portion of the sheet is pressed between the support member (3) and the blade member (4) such that the sheet is perforated, wherein the support member (3) is curved and wherein the perforation device (1) comprises a drive assembly configured to move the blade member (4) and/or the support member (3) in a rocking motion such that only a portion of the blade perforates the sheet wherein the portion of the blade member (4) perforating the sheet moves along the length of the blade member (4) as the rocking motion progresses.

2. The perforation device (1) according to claim 1, wherein the drive assembly comprises a rotatable shaft (6), wherein a left cam member (7) is attached to the shaft at a left portion of the shaft (6), wherein a right cam member (8) is attached to the shaft (6) at a right portion of the shaft (6),
wherein the blade member (4) is provided with a left cam follower (9) configured to cooperate with the left cam member (7) to control the movement of the left portion of the blade member (4) in response to rotation of the shaft (6),
wherein the blade member (4) is provided with a right cam follower (10) configured to cooperate with the right cam member (8) to control the movement of the right portion of the blade member (4) in response to rotation of the shaft (6).

3. The perforation device (1) according to claim 2, wherein each one of the left cam member (7) and the right cam member (8) comprises a respective rotary bearing (11) defining a respective cylindrical cam surface, where the rotary bearing (11) is attached off-center with respect to the central axis (12) of the shaft (6).

4. The perforation device (1) according to claim 2, wherein the left cam member (7) is attached to the shaft (6) with an angular offset (13) to the right cam member with respect to said central axis (12).

5. The perforation device (1) according to claim 1, further comprising biasing means (14) configured to force apart the blade member (4) and the support member (3).

6. A document processing device comprising a perforation device (1) according to claim 1.

7. The perforation device (1) according to claim 3, wherein the left cam member (7) is attached to the shaft (6) with an angular offset (13) to the right cam member with respect to said central axis (12).

8. The perforation device (1) according to claim 2, further comprising biasing means (14) configured to force apart the blade member (4) and the support member (3).

9. The perforation device (1) according to claim 3, further comprising biasing means (14) configured to force apart the blade member (4) and the support member (3).

10. The perforation device (1) according to claim 4, further comprising biasing means (14) configured to force apart the blade member (4) and the support member (3).

11. A document processing device comprising a perforation device (1) for a document processing machine, wherein the perforation device (1) comprises a frame (2), a support member (3) and a blade member (4) attached to the frame (2), wherein the support member (3) and the blade member (4) are movable relative to each other and configured to cooperate by movement between an open position in which a gap (5) for insertion of a sheet is present between the support member (3) and the blade member (4), and a perforating position in which the gap is at least partially closed such that at least a portion of the sheet is pressed between the support member (3) and the blade member (4) such that the sheet is perforated, wherein the support member (3) is curved and wherein the perforation device (1) comprises a drive assembly configured to move the blade member (4) and/or the support member (3) in a rocking motion such that only a portion of the blade perforates the sheet wherein the portion of the blade member (4) perforating the sheet moves along the length of the blade member (4) as the rocking motion progresses.

12. The document processing device according to claim 11, wherein the drive assembly comprises a rotatable shaft (6), wherein a left cam member (7) is attached to the shaft at a left portion of the shaft (6), wherein a right cam member (8) is attached to the shaft (6) at a right portion of the shaft (6),
wherein the blade member (4) is provided with a left cam follower (9) configured to cooperate with the left cam member (7) to control the movement of the left portion of the blade member (4) in response to rotation of the shaft (6),
wherein the blade member (4) is provided with a right cam follower (10) configured to cooperate with the right cam member (8) to control the movement of the right portion of the blade member (4) in response to rotation of the shaft (6).

13. The document processing device according to claim 12, wherein each one of the left cam member (7) and the right cam member (8) comprises a respective rotary bearing (11) defining a respective cylindrical cam surface, where the rotary bearing (11) is attached off-center with respect to the central axis (12) of the shaft (6).

14. The document processing device according to claim 12, wherein the left cam member (7) is attached to the shaft (6) with an angular offset (13) to the right cam member with respect to said central axis (12).

15. The document processing device according to claim 11, further comprising biasing means (14) configured to force apart the blade member (4) and the support member (3).

16. The document processing device according to claim 13, wherein the left cam member (7) is attached to the shaft (6) with an angular offset (13) to the right cam member with respect to said central axis (12).

17. The document processing device according to claim 12, further comprising biasing means (14) configured to force apart the blade member (4) and the support member (3).

18. The document processing device according to claim 13, further comprising biasing means (14) configured to force apart the blade member (4) and the support member (3).

19. The document processing device according to claim 14, further comprising biasing means (14) configured to force apart the blade member (4) and the support member (3).
